(19) United States
(12) Patent Application Publication
(10) Pub. No.: US 2026/0192521 A1
(43) Pub. Date: Jul. 9, 2026

(54) OPTICAL MODELING APPARATUS AND OPTICAL MODELING METHOD

(71) Applicant: SONY GROUP CORPORATION, TOKYO (JP)

(72) Inventors: HIROYUKI YANAGISAWA, TOKYO (JP); YUSUKE KONO, TOKYO (JP)

(21) Appl. No.: 19/132,093

(22) PCT Filed: Nov. 6, 2023
(86) PCT No.: PCT/JP2023/039812

§ 371 Date: May 22, 2025

(30) Foreign Application Priority Data
Nov. 30, 2022 (JP) 2022-191282

(51) Int. Cl. B29C 64/273; B29C 64/135; B33Y 10/00; B33Y 30/00

(52) U.S. Cl. CPC B29C 64/273; B29C 64/135; B33Y 10/00; B33Y 30/00

(57) ABSTRACT

An optical modeling apparatus includes a spatial light modulator that modulates a laser beam so that the laser beam has a light intensity pattern in a plane direction intersecting a traveling direction of the laser beam and outputs the laser beam as modulated light, a first imaging system that images the modulated light from the spatial light modulator, an optical element that controls the modulated light from the first imaging system and outputs the modulated light as control light, and a second imaging system that images the control light from the optical element and focuses and applies the control light onto a photocurable material. The optical element is disposed between the first imaging system and the second imaging system so as to suppress a light intensity of the control light at a position other than a focusing position of the second imaging system on the photocurable material.

### FIELD

The present disclosure relates to an optical modeling apparatus and an optical modeling method.

### BACKGROUND

There is known an optical modeling technology in which light is patterned by a spatial light modulator (SLM), and focused and applied onto a photocurable resin (e.g., Patent Literature 1).

### CITATION LIST

### Patent Literature

Patent Literature 1: JP 2002-207202 A

### SUMMARY

### Technical Problem

When a spatial light modulator is used, a plurality of light beams of patterned light is collectively focused and applied, so that the speed of optical modeling is increased. On the other hand, there is a possibility that curing occurs at an unintended position other than a focusing position due to an influence of sidelobes, background noise, speckles, and the like of each light beam. As a result, the modeling accuracy is reduced, and precision modeling becomes difficult.

One aspect of the present disclosure is to achieve both high speed and precision modeling.

### Solution to Problem

An optical modeling apparatus according to one aspect of the present disclosure includes: a spatial light modulator that modulates a laser beam so that the laser beam has a light intensity pattern in a plane direction intersecting a traveling direction of the laser beam, the spatial light modulator outputting the laser beam modulated as modulated light; a first imaging system that images the modulated light from the spatial light modulator; an optical element that controls the modulated light from the first imaging system, the optical element outputting the modulated light controlled as control light; and a second imaging system that images the control light from the optical element, the second imaging system focusing and applying the control light onto a photocurable material, wherein the optical element is disposed between the first imaging system and the second imaging system in order to suppress a light intensity of the control light at a position other than a focusing position of the second imaging system on the photocurable material.

An optical modeling method according to one aspect of the present disclosure includes: by a spatial light modulator, modulating a laser beam so that the laser beam has a light intensity pattern in a plane direction intersecting a traveling direction of the laser beam, and outputting the laser beam modulated as modulated light; imaging, by a first imaging system, the modulated light from the spatial light modulator;

by an optical element, controlling the modulated light from the first imaging system, and outputting the modulated light controlled as control light; and by a second imaging system, imaging the control light from the optical element, and focusing and applying the control light onto a photocurable material, wherein the optical element is disposed between the first imaging system and the second imaging system so as to suppress a light intensity of the control light at a position other than a focusing position of the second imaging system on the photocurable material.

### BRIEF DESCRIPTION OF DRAWINGS

FIG. 1 is a diagram illustrating an example of a schematic configuration of an optical modeling apparatus 1 according to a first embodiment.

FIG. 2 is a diagram illustrating an example of a schematic configuration of a spatial light modulator 4.

FIG. 3 is a diagram illustrating an example of a schematic configuration of an optical element 5.

FIG. 4 is a diagram illustrating an example of a light intensity pattern of modulated light LM from an imaging system 3.

FIG. 5 is a diagram illustrating an example of transmittance of the optical element 5.

FIG. 6 is a diagram illustrating an example of a light intensity pattern of control light CLM from the optical element 5.

FIG. 7 is a diagram illustrating an example of a schematic configuration of an optical modeling apparatus 1 according to a second embodiment.

FIG. 8 is a diagram illustrating an example of a schematic configuration of an optical element 5A.

FIG. 9 is a diagram illustrating an example of a schematic configuration of the optical element 5A.

FIG. 10 is a diagram illustrating an example of a delay pattern.

FIG. 11 is a diagram illustrating an example of collecting control light CLM from the optical element 5A.

FIG. 12 is a diagram illustrating a comparative example.

FIG. 13 is a diagram illustrating an example of a delay pattern.

FIG. 14 is a diagram illustrating an example of a schematic configuration of an optical modeling apparatus 1 according to a third embodiment.

FIG. 15 is a diagram schematically illustrating collection of the control light CLM to be focused and applied.

FIG. 16 is a diagram schematically illustrating a waveform of an optical pulse at each position.

FIG. 17 is a diagram schematically illustrating a waveform of an optical pulse at each position.

FIG. 18 is a diagram schematically illustrating a waveform of an optical pulse at each position.

### DESCRIPTION OF EMBODIMENTS

Hereinafter, embodiments of the present disclosure will be described with reference to the drawings. In each of the following embodiments, the same components are given the same reference signs to omit redundant description.

The present disclosure will be described according to the following order of items.
0. Introduction
1. First Embodiment
2. Second Embodiment
3. Third Embodiment
4. Modifications
5. Examples of effect

### 0. Introduction

An optical modeling apparatus that utilizes two-photon curing to fabricate nanoscale precision three-dimensional structures has been developed. For example, resin is scanned with an ultrashort pulse light source of 800 nm. In order to further increase the speed, voxel size control, beam splitting by a diffractive optical element (DOE), multi-point simultaneous curing by a spatial light modulator, and the like have been proposed. However, when light is focused onto regions temporally and spatially close to each other, a light intensity at a position other than a focusing position increases due to an influence of sidelobe, background noise, speckle, and the like (hereinafter also referred to as a sidelobes), and there is a possibility that unintended curing occurs therein. The modeling accuracy is reduced, and precision modeling becomes difficult. According to the disclosed technology, curing in an unintended region is suppressed even in multi-point simultaneous curing by using the spatial light modulator. Both high speed and precision optical modeling is achievable.

### 1. First Embodiment

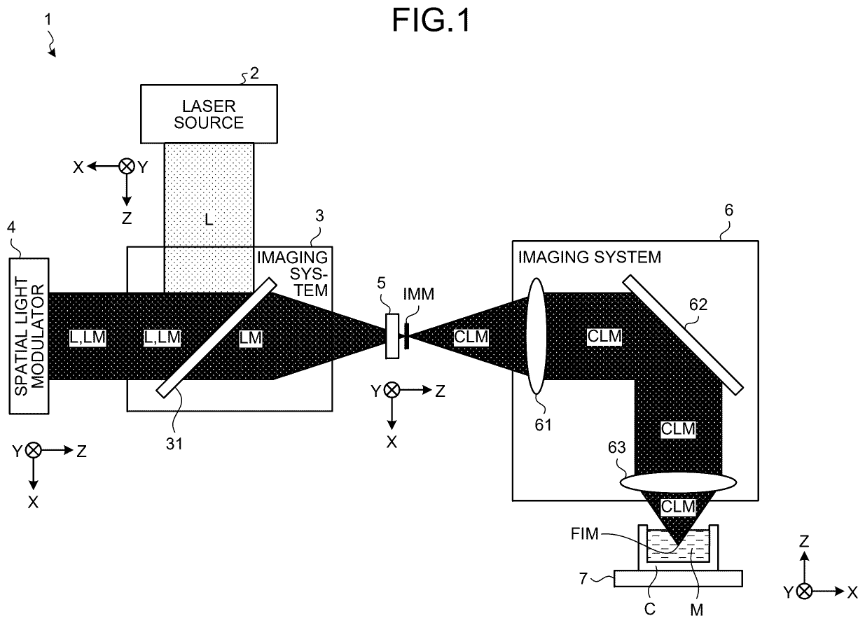

FIG. 1 is a diagram illustrating an example of a schematic configuration of an optical modeling apparatus 1 according to a first embodiment. In the optical modeling apparatus 1, a laser beam is focused and applied onto a photocurable material M to fabricate a desired modeled object. The photocurable material M is accommodated in a container C, for example, in a state before curing. An example of the photocurable material M is resin or the like. Examples of the resin include an epoxy resin and an acrylic resin.

The optical modeling apparatus 1 includes a laser source 2, an imaging system 3, a spatial light modulator 4, an optical element 5, an imaging system 6, and a stage 7. For convenience of description, an XYZ coordinate system in some elements is also illustrated. A Z-axis direction corresponds to an optical axis direction. Unless otherwise specified, each element is assumed to have a shape extending in a direction intersecting the optical axis direction.

The laser source 2 outputs a laser beam L. The laser beam L is configured to include a light beam capable of curing the photocurable material M, and is pulsed and output so as to cure the photocurable material M, for example, by two-photon absorption. An example of a wavelength of the laser beam L is approximately 800 nm. A pulse width may be a femto second order. The laser beam L may have a width in a plane direction intersecting (e.g., orthogonal to) a traveling direction. Hereinafter, the laser beam L is assumed to be a planar laser beam having a width in an XY plane direction. An intensity pattern (intensity distribution) of the laser beam L in the XY plane direction may be constant.

The imaging system 3 guides light from the laser source 2 to the spatial light modulator 4. In addition, the imaging system 3 forms an image with light (modulated light LM to be described later) from the spatial light modulator 4 and guides the light to the imaging system 6. The imaging system 3 includes a half mirror 31 so as to have a splitter function in this example. The half mirror 31 reflects a part of the laser beam L from the laser source 2 toward the spatial light modulator 4 and allows a part of the modulated light LM from the spatial light modulator 4 to pass therethrough. The half mirror 31 forms an image of the modulated light LM that has passed through, and guides the modulated light LM to the imaging system 6. Note that, for example, when the laser beam L is obliquely incident on the spatial light modulator 4, the imaging system 3 may not have the splitter function.

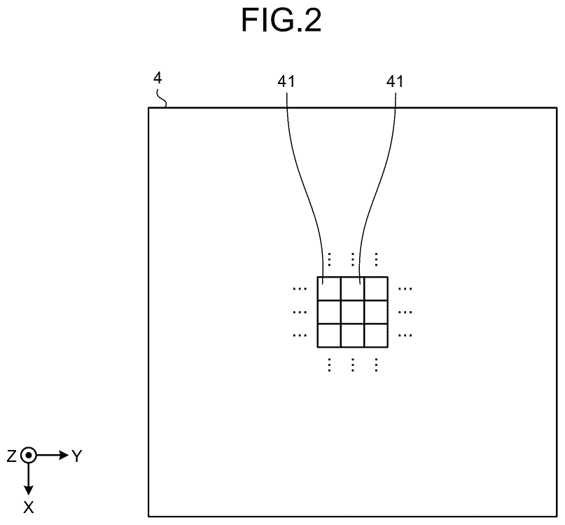

The spatial light modulator 4 spatially modulates the laser beam L from the imaging system 3. The spatial light modulator 4 modulates the laser beam L so as to have a light intensity pattern in the XY plane direction, and outputs the laser beam L modulated as the modulated light LM. In this example, the spatial light modulator 4 is a reflective spatial light modulator, and reflects the laser beam L so as to obtain the modulated light LM. This will be described with reference to FIG. 2.

FIG. 2 is a diagram illustrating an example of a schematic configuration of the spatial light modulator 4. The spatial light modulator 4 includes a plurality of portions. Each portion is referred to as a pixel 41 in the drawing. In this example, a plurality of pixels 41 is arranged in an array in an X-axis direction and a Y-axis direction. The spatial light modulator 4 is configured to be able to individually control reflectance of each of the plurality of pixels 41 with respect to the laser beam L. Examples of the spatial light modulator 4 include a liquid crystal panel and a digital mirror device (DMD). By dynamically controlling the reflectance of each pixel 41, the laser beam L can be patterned (i.e., spatially modulated) so as to have a desired light intensity pattern in the XY plane direction. Note that the spatial light modulator 4 may be a phase control type spatial light modulator instead of a reflectance control type spatial light modulator as described here. However, unless otherwise specified, the spatial light modulator 4 is assumed to be the reflectance control type spatial light modulator in the following description.

Returning to FIG. 1, the imaging system 3 is a first imaging system that forms an image of the modulated light LM from the spatial light modulator 4. An image obtained by imaging the modulated light LM by the imaging system 3 is referred to as an intermediate image IMM in the drawing.

The optical element 5 controls the modulated light LM from the imaging system 3 and outputs the modulated light LM as control light CLM. Details of the optical element 5 will be described later.

The imaging system 6 is a second imaging system that images the control light CLM from the optical element 5 on the photocurable material M, and focuses and applies the control light CLM onto the photocurable material M. In this example, the imaging system 6 includes a lens 61, a mirror 62, and a lens 63. The lens 61 is a condenser lens that directs the control light CLM from the optical element 5 to the mirror 62. The mirror 62 reflects the control light CLM from the lens 61 toward the mirror 62. The lens 63 focuses the control light CLM from the mirror 62 onto the photocurable material M.

The lens 63 functions as an imaging lens to form an image of the control light CLM, and focuses the control light CLM at a focusing position (e.g., focal point). The image formed by the lens 63 is referred to as a reduced image FIM in the drawing. The reduced image FIM may be smaller than the intermediate image IMM.

The stage 7 supports the container C accommodating the photocurable material M and moves in a vertical direction and front-back and left-right directions (Z-axis direction and XY plane direction). As a result, the focusing position of the lens 63 can be moved to an arbitrary position in the photocurable material M. In other words the control light CLM from the imaging system 6 can be focused and applied onto an arbitrary position of the photocurable material M.

An optical modeling procedure will be described. First, the control light CLM having a certain light intensity pattern is focused and applied onto a lowermost layer (near the surface on the Z-axis negative direction side) of the photocurable material M. A portion having high light intensity in the photocurable material M is cured. Scanning in the XY plane direction may be performed as necessary. Next, the stage 7 moves in the Z-axis direction (e.g., Z-axis negative direction), and the control light CLM having another light intensity pattern is focused and applied onto a next layer of the photocurable material M. By repeating these operations, a three-dimensional object is fabricated from the photocurable material M.

The modulated light LM output from the spatial light modulator 4 includes a plurality of light beams. The plurality of light beams is collectively focused and applied onto the photocurable material M, so that the speed of optical modeling is increased. However, when spatially adjacent light beams, e.g., light beams from adjacent pixels 41, are simultaneously focused and applied, the light intensity at a position other than the focusing position increases due to an influence of sidelobes or the like of each light beam. As a result, unintended curing may occur. The modeling accuracy is reduced, and precision modeling becomes difficult.

In order to solve the above problem, the optical modeling apparatus 1 according to the embodiment includes the optical element 5. The optical element 5 is disposed between the imaging system 3 and the imaging system 6 so as to suppress the light intensity of the control light CLM at a position other than the focusing position of the imaging system 6 on the photocurable material M. The optical element 5 is disposed at a position of the intermediate image IMM or closer to the position of the intermediate image IMM (e.g., near the intermediate image IMM) than the imaging system 3 and the imaging system 6. The control of the modulated light LM by the optical element 5 can also be referred to as the control of the intermediate image IMM. As will be appropriately described later, the control of the modulated light LM by the optical element 5 may include phase control.

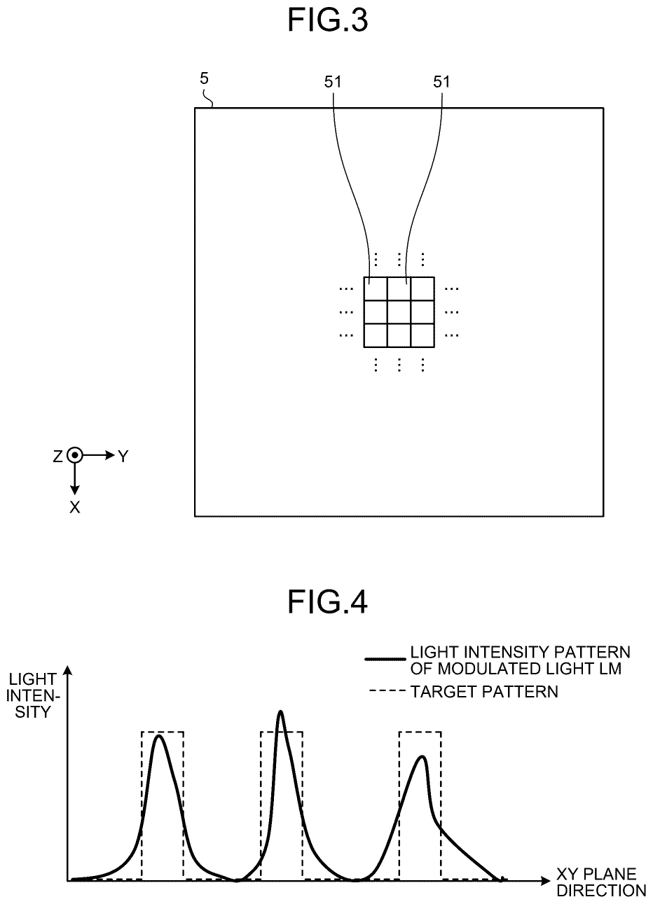

The optical element 5 of the optical modeling apparatus 1 according to the first embodiment controls the light intensity of light beam in each portion in the plane direction (XY plane direction) of the modulated light LM from the imaging system 3. In the example illustrated in FIG. 1, the optical element 5 is a transmission type optical element, and controls transmittance of each of a plurality of portions to which light beams from respective portions in the plane direction of the modulated light LM enter. This will be described with reference to FIG. 3.

FIG. 3 is a diagram illustrating an example of a schematic configuration of the optical element 5. The optical element 5 includes a plurality of pixels 51. In this example, the plurality of pixels 51 is arranged in an array in the X-axis direction and the Y-axis direction. Light beams from portions in the plane direction (XY plane direction) of the modulated light LM in the imaging system 3 enter respective pixels 51. For example, in the case of the reflectance control type spatial light modulator 4, one pixel 51 of the optical element 5 corresponds to one pixel 41 of the spatial light modulator 4. Light beams from pixels 41 enter corresponding pixels 51 of the optical element 5. Note that, in the case of the phase control type spatial light modulator 4, one pixel 41 and one pixel 51 need not correspond to each other at 1:1.

The optical element 5 is configured to be able to individually control the transmittance of each pixel 51. An example of the optical element 5 is a liquid crystal spatial phase modulator. The transmittance of the light beam is controlled by phase control of the light beam passing through a polarizing plate and liquid crystal molecule. The optical element 5 controls the transmittance of each pixel 51 such that the light intensity pattern of the control light CLM comes close to a target pattern than the light intensity pattern of the modulated light LM. The target pattern indicates an ideal light intensity pattern from which the influence of sidelobes, for example, is eliminated. The control light CLM having a light intensity pattern close to the target pattern is focused and applied onto the photocurable material M, so that the light intensity at a position other than the focusing position can be suppressed. Description will be given with reference to FIGS. 4 to 6.

FIG. 4 is a diagram illustrating an example of the light intensity pattern of the modulated light LM from the imaging system 3. A horizontal axis of a graph indicates a position in the XY plane direction, and a vertical axis of the graph indicates the light intensity. The light intensity pattern of the modulated light LM is different from the target pattern. Depending on the position in the XY plane direction, the light intensity of the modulated light LM is larger or smaller than the light intensity of the target pattern.

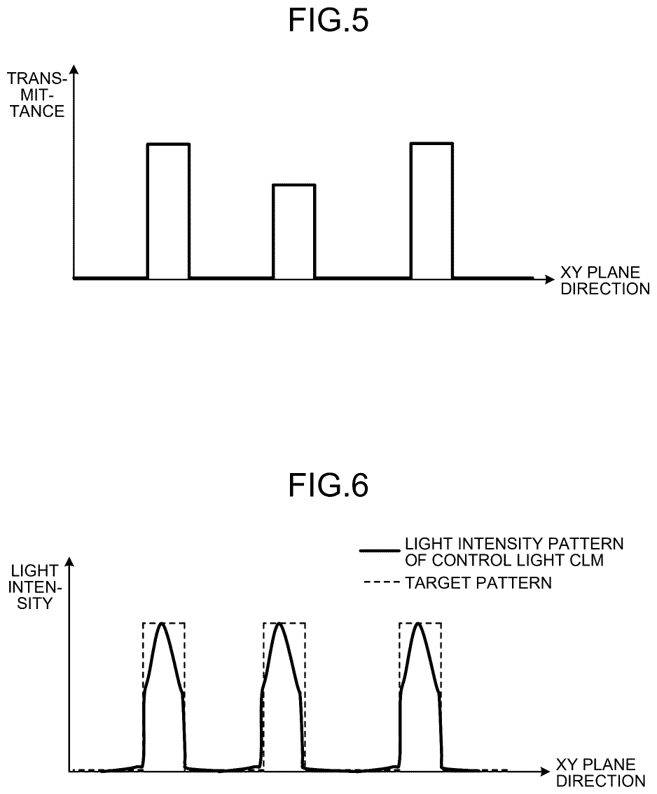

FIG. 5 is a diagram illustrating an example of the transmittance of the optical element 5. The transmittance in the XY plane direction is schematically illustrated by a graph. The transmittance of each pixel 51 (FIG. 3) is individually set. By reducing the transmittance of the pixel 51, the light intensity of light beam of a corresponding portion can be reduced.

For example, the transmittance of the corresponding pixel 51 is controlled so as to reduce the transmittance of the light intensity of a portion of the modulated light LM that is larger than the light intensity of the target pattern. A specific transmittance of each pixel 51 may be set based on, for example, a deviation amount of the light intensity pattern of the modulated light LM with respect to the target pattern. The deviation amount and the like can be identified from design data, experimental data, actual measurement data, and the like of the optical modeling apparatus 1.

FIG. 6 is a diagram illustrating an example of the light intensity pattern of the control light CLM from the optical element 5. The light intensity pattern of the control light CLM from the optical element 5 is closer to the target pattern than the light intensity pattern of the modulation light LM. It can also be said that uniformity (in-plane uniformity) of a focusing pattern is improved in the plane direction (XY plane direction) of the control light CLM.

For example, the control light CLM as described above is focused and applied onto the photocurable material M by the imaging system 6, so that the light intensity of the control light CLM at a position other than the focusing position of the imaging system 6 is suppressed. Reduction of the modeling accuracy is suppressed, and precision modeling is achievable. For example, a voxel size (in-plane voxel size) in the plane direction of the control light CLM can be made uniform. Therefore, it is possible to achieve both high speed and precision modeling.

As another method, the use of an algorithm or a feedback loop may be assumed. However, this leads to addition of an optical system, an increase in calculation time, and the like. It is also conceivable to use only amplitude modulation without using the phase modulation. However, the optical efficiency will decrease. Addition of a curing inhibitor is also conceivable. However, local adjustment cannot be performed. The use of curing inhibition light is also conceivable. However, local correction is difficult. According to the optical modeling apparatus 1 of the embodiment, it is possible to perform faster and lighter correction calculation (repetition not necessary) than the above methods. The optical efficiency can be increased, and local correction is also possible.

In the above description, the case where the optical element 5 is the liquid crystal spatial phase modulator has been described as an example. However, the configuration of the optical element 5 is not limited thereto. Another example of the optical element 5 is DMD. Furthermore, the optical element 5 may be a reflection type optical element. In that case, the optical element 5 is configured to be able to individually control the reflectance of each pixel 51.

### 2. Second Embodiment

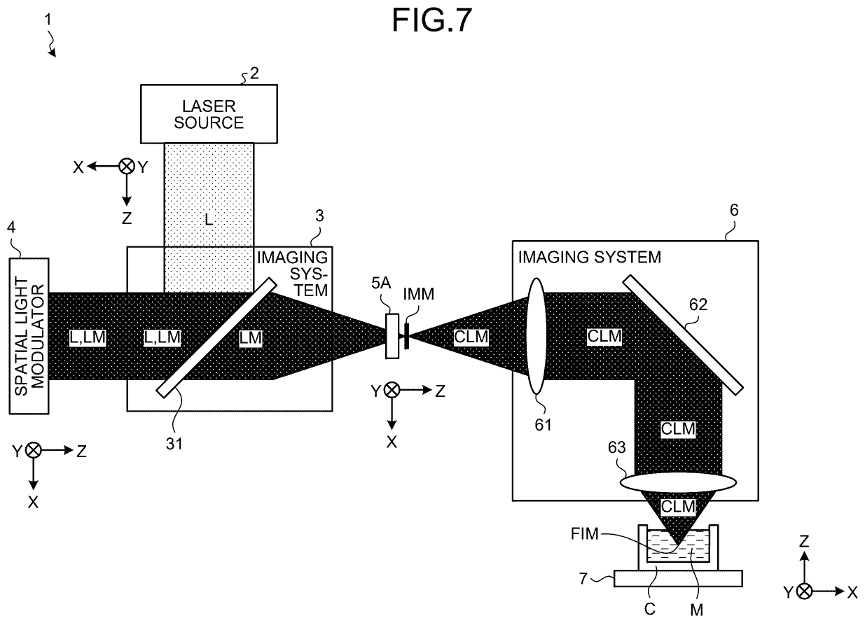

FIG. 7 is a diagram illustrating an example of a schematic configuration of an optical modeling apparatus 1 according to a second embodiment. An optical element of the optical modeling apparatus 1 according to the second embodiment is referred to as an optical element 5A. The optical element 5A controls the modulated light LM from the imaging system 3 such that adjacent light beams of the light beams in the plane direction (XY plane direction) of the control light CLM reach the focusing position of the imaging system 6 at different timings.

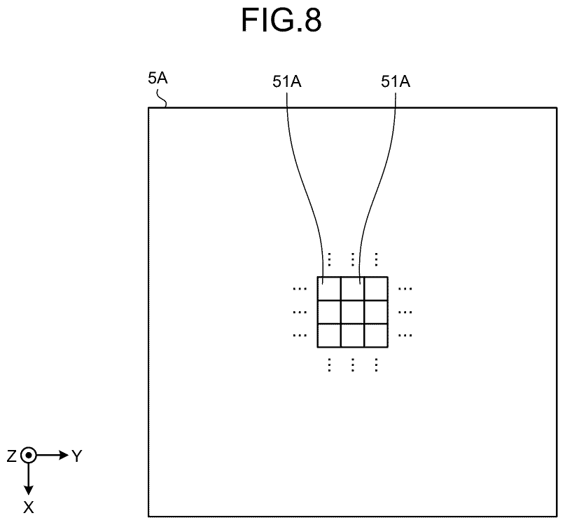

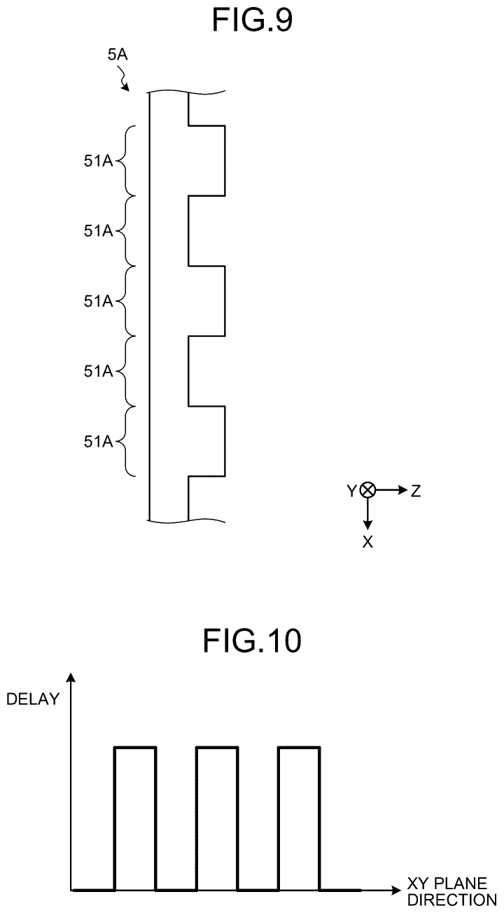

FIGS. 8 and 9 are diagrams illustrating examples of a schematic configuration of the optical element 5A. The optical element 5A includes a plurality of pixels 51A. In this example, the plurality of pixels 51A is arranged in an array in the X-axis direction and the Y-axis direction. Light beams from portions in the plane direction (XY plane direction) of the modulated light LM in the imaging system 3 enter respective pixels 51A. For example, as described above, one pixel 51A of the optical element 5A may correspond to one pixel 41 of the spatial light modulator 4. A light beam from the pixel 41 enters corresponding pixel 51A of the optical element 5A.

Adjacent pixels 51A of the plurality of pixels 51A apply different optical path lengths from each other to entering light beams. In this example, the optical element 5A is a plate-like element configured such that the adjacent pixels 51A of the plurality of pixels 51A have different thicknesses (lengths in the Z-axis direction). Examples of the material of the optical element 5A are glass and resin. A difference in thicknesses between the pixels 51A gives a difference in optical path lengths. As the thickness of the pixel 51A increases, the optical path length increases, and a delay of the light beam passing through the pixel 51A increases by the phase control. As the delay increases arrival of the light beam to the focusing position is delayed.

In the example illustrated in FIG. 9, the pixel 51A having a large thickness and the pixel 51A having a small thickness are alternately arranged. The light beams that have passed through the pixels 51A having a large thickness are delayed more than the light beams that have passed through the pixels 51A having a small thickness. In this manner, the timings at which the adjacent light beams reach the focusing position of the imaging system 6 can be made different from each other.

FIG. 10 is a diagram illustrating an example of a delay pattern. Corresponding to FIG. 9 described above, the delay pattern in the XY plane direction is schematically illustrated. In this example, a portion having a large delay and a portion having a small delay are alternately arranged in the XY plane direction.

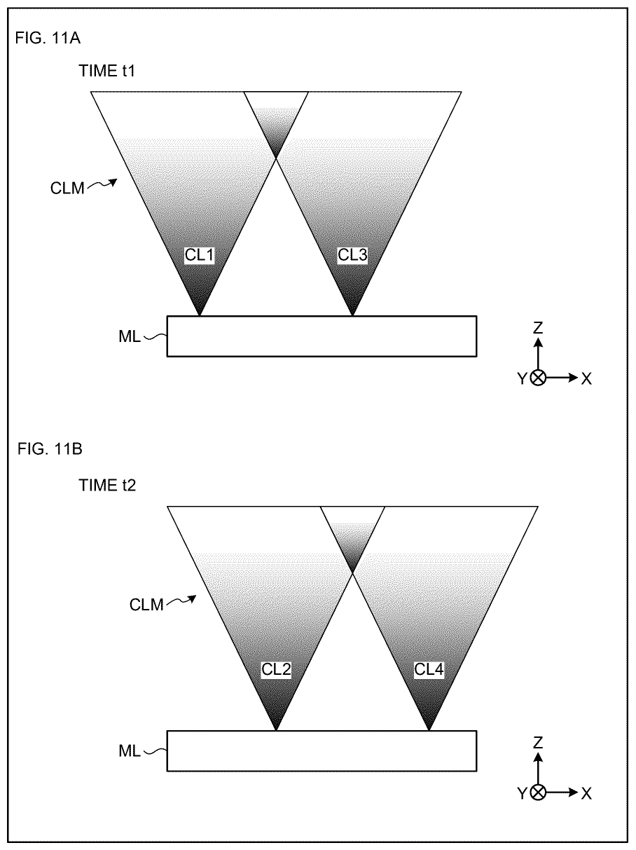

FIG. 11 is a diagram illustrating an example of focusing the control light CLM from the optical element 5A. A light focusing position on the photocurable material M is referred to as a light collecting layer ML in the drawing. Some of the light beams configuring the control light CLM to be focused are referred to as a collected light beam CL1 to a collected light beam CL4 in the drawing. In this example, the collected light beam CL1 to the collected light beam CL4 are positioned in this order in an X axis positive direction.

The collected light beam CL1 and the collected light beam CL2 are light beams adjacent to each other, and are light beams after passing through the adjacent pixels 51A of the optical element 5. Since the respective delays of the collected light beam CL1 and the collected light beam CL2 in the optical element 5A are different, the collected light beam CL1 and the collected light beam CL2 reach the light collecting layer ML at different timings. The same applies to the collected light beam CL2 and the collected light beam CL3, and the collected light beam CL3 and the collected light beam CL4.

Specifically, as illustrated in (A) of FIG. 11, the collected light beam CL1 and the collected light beam CL3 reach the light collecting layer ML at time t1. As illustrated in (B) of FIG. 11, the collected light beam CL2 and the collected light beam CL4 reach the light collecting layer ML at another time t2. Therefore, the collected light beam CL1 and the collected light beam CL2 adjacent to each other reach the light collecting layer ML at different timings. The same applies to the collected light beam CL2 and the collected light beam CL3, and the collected light beam CL3 and the collected light beam CL4.

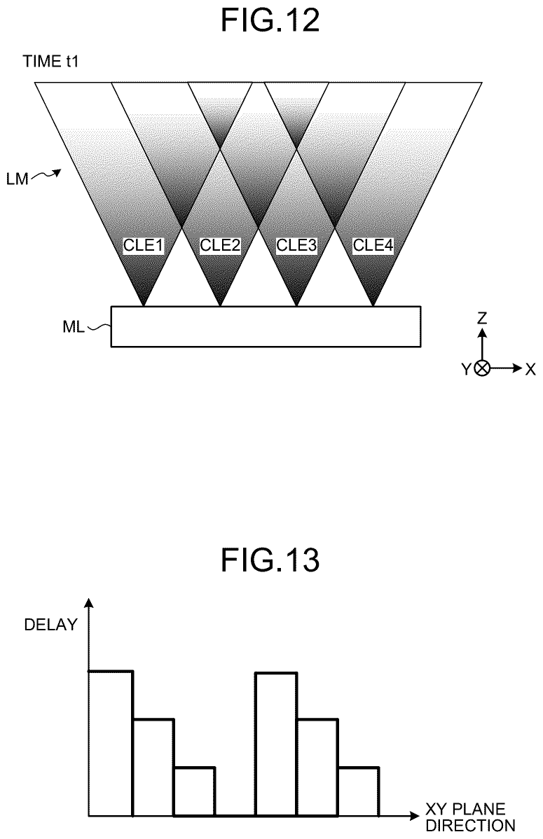

When the optical modeling apparatus 1 does not include the optical element 5A, the adjacent light beams reach the light collecting layer ML at the same timing. This will be described with reference to FIG. 12.

FIG. 12 is a diagram illustrating a comparative example. The modulated light LM from the spatial light modulator 4 is focused and applied onto the photocurable material M without passing through the optical element 5A. Some of the light beams configuring the modulated light LM to be focused are referred to as a collected light beam CLE1 to a collected light beam CLE4 in the drawing. In this example, the collected light beam CLE1 to the collected light beam CLE4 are positioned in this order in the X-axis positive direction.

At time t1, the collected light beam CLE1 to the collected light beam CLE4 simultaneously reach the light collecting layer ML. In this case, overlapping positions of the collected light beams increase at positions other than the light collecting layer ML. In particular, the light intensity increases at a position where the collected light beam CL1 and the collected light beam CL2 adjacent to each other overlap with each other, a position where the collected light beam CL2 and the collected light beam CL3 overlap with each other, and a position where the collected light beam CL3 and the collected light beam CL4 overlap with each other. Such interaction of light beams may result in unintended curing.

On the other hand, for example, as illustrated in FIG. 11 described above, the light intensity at positions other than the focusing position is suppressed by shifting the timing at which the adjacent light beams reach the focusing position in the imaging system 6. Reduction of the modeling accuracy is suppressed, and precision modeling is achievable. Therefore, it is possible to achieve both high speed and precision modeling.

The above gives an example of a case where the optical element 5A has a configuration in which the pixel 51A having a large light delay and the pixel 51A having a small light delay are alternately arranged. However, the configuration of the optical element 5A is not limited thereto. An example of another configuration will be described with reference to FIG. 13.

FIG. 13 is a diagram illustrating an example of a delay pattern. The light delay of the pixels 51A arranged in the XY plane direction gradually increases or decreases. In this example, in the XY plane direction, the light delay changes stepwise in four step, and the change is repeated.

In the above description, the case where the optical element 5A is a plate-like element such as of glass or resin has been described as an example. However, the configuration of the optical element 5A is not limited thereto. Other examples of the optical element 5A are a liquid crystal spatial phase modulator and a DMD. A similar effect is achievable by changing or shifting polarization between adjacent light beams.

### 3. Third Embodiment

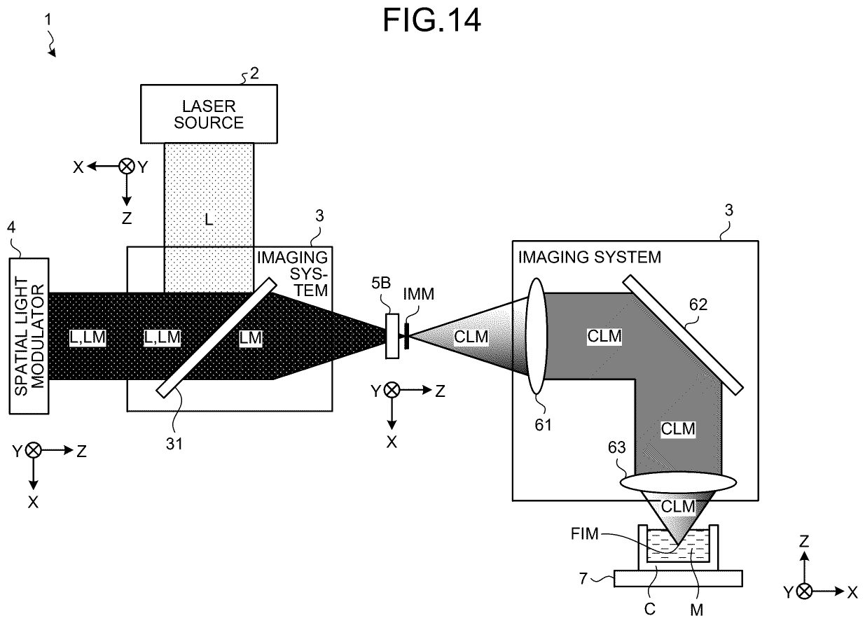

FIG. 14 is a diagram illustrating an example of a schematic configuration of an optical modeling apparatus 1 according to a third embodiment. An optical element of the optical modeling apparatus 1 according to the third embodiment is referred to as an optical element 5B. The optical element 5B controls the modulated light LM from the imaging system 3 such that a pulse width of the control light CLM at a position other than the focusing position in the imaging system 6 is longer than a pulse width of the control light CLM at the focusing position. An example of the optical element 5C is a diffractive optical element.

Since the laser beam L is pulsed, the modulated light LM is also pulsed. The modulated light LM includes light having a plurality of different wavelengths. The optical element 5B varies the traveling direction of the modulated light LM having different wavelengths from the imaging system 3 by phase control, and outputs the modulated light LM as the control light CLM. As a result, in the control light CLM, positions of the light having different wavelengths in the XY plane direction are different. The control light CLM is focused and applied onto the photocurable material M by the imaging system 6.

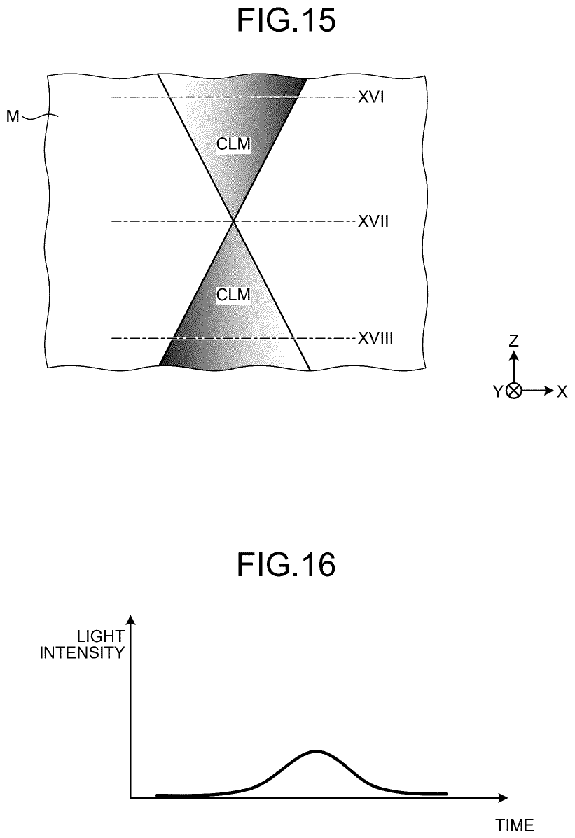

FIG. 15 is a diagram schematically illustrating collection of the control light CLM to be focused and applied. A line XVI indicates a position before the focusing position. A line XVII indicates the focusing position. A line XVIII indicates a position beyond the focusing position.

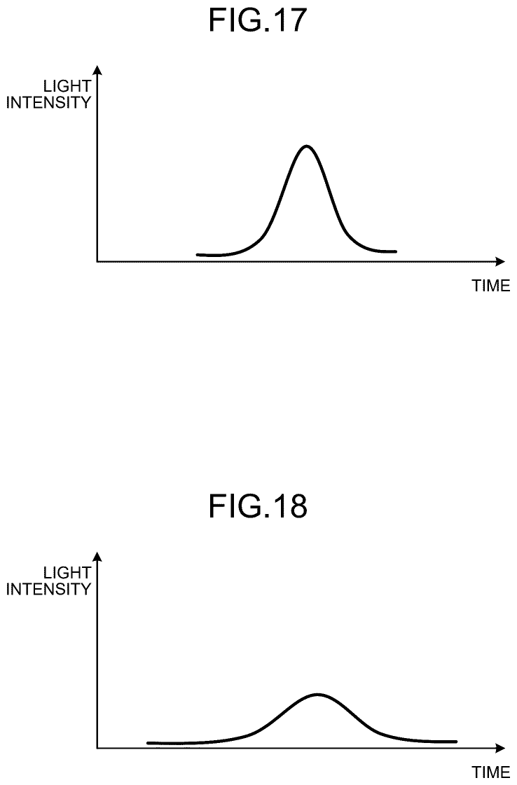

FIGS. 16 to 18 are diagrams schematically illustrating waveforms of optical pulses at respective positions. The horizontal axis of graphs indicates time. The vertical axis of the graphs indicates the light intensity. FIG. 16 illustrates a waveform at a position before the focusing position (position of the line XVI in FIG. 15). FIG. 17 illustrates a waveform at the focusing position (position of the line XVII in FIG. 15). FIG. 18 illustrates a waveform at a position beyond the focusing position (position of the line XVIII in FIG. 15).

As illustrated in FIGS. 16 and 18, at the position before the focusing position and the position beyond the focusing position, the pulse width becomes long (pulse rounding) and a peak of the light intensity is small. This is because the light having different wavelengths is dispersed in the XY plane direction to reduce a light density. Unnecessary curing can be suppressed.

As illustrated in FIG. 17, at the focusing position, the pulse width becomes short (pulse becomes sharp), and the peak of the light intensity is large. This is because the light having different wavelengths gathers at one position to increase the light density. Curing can be reliably performed at the focusing position.

### 4. Modifications

The technology disclosed is not limited to the above embodiments. For example, the optical element 5 according to the first embodiment, the optical element 5A according to the second embodiment, and the optical element 5B according to the third embodiment described above may be arbitrarily combined. In other words, the optical element may have a configuration in which two or more optical elements of the optical element 5, the optical element 5A, and the optical element 5B are combined. An optical modeling method using the configuration of the optical modeling apparatus 1 is also one of the embodiments.

### 5. Examples of Effect

For example, the technologies described above are specified as follows. One of the technologies disclosed is the optical modeling apparatus 1. As described with reference to FIGS. 1 to 11 and FIGS. 13 to 18, the optical modeling apparatus 1 includes the spatial light modulator 4, the imaging system 3, the optical element 5 (optical element 5A and optical element 5B are also applicable), and the imaging system 6. The spatial light modulator 4 modulates the laser beam L so as to have the light intensity pattern in the plane direction (XY plane direction) intersecting the traveling direction of the laser beam L, and outputs the modulated light as the modulated light LM. The imaging system 3 is the first imaging system that forms an image of the modulated light LM from the spatial light modulator 4. The optical element 5 controls the modulated light LM from the imaging system 3 and outputs the modulated light LM as the control light CLM. The imaging system 6 is the second imaging system that images the control light CLM from the optical element 5, and focuses and applies the control light CLM onto the photocurable material M. The optical element 5 is disposed between the imaging system 3 and the imaging system 6 so as to suppress the light intensity of the control light CLM at a position other than the focusing position of the imaging system 6 on the photocurable material M.

According to the optical modeling apparatus 1 described above, the speed of optical modeling is increased by the use of the spatial light modulator 4. In addition, the optical element 5 suppresses the light intensity of the control light CLM at a position other than the focusing position of the imaging system 6 on the photocurable material M. Reduction of the modeling accuracy is suppressed, and precision modeling is achievable. Therefore, it is possible to achieve both high speed and precision modeling.

As described with reference to FIG. 1 and the like, the optical element 5 may be disposed at a position of an image obtained by imaging the modulated light LM by the imaging system 3 (intermediate image IMM) or closer to the position of the image than the imaging system 3 and the imaging system 6. For example, the optical element 5 can be arranged in this manner to control the modulated light LM from the imaging system 3.

As described with reference to FIGS. 1 to 6, the optical element 5 may control the light intensity of the light beam in each portion in the plane direction (XY plane direction) of the modulated light LM from the imaging system 3. For example, the optical element 5 may include the plurality of pixels 51 to which light beams of respective portions in the plane direction of the modulated light LM from the imaging system 3 enter, and may control the transmittance or the reflectance of each of the plurality of pixels 51. In that case, the optical element 5 may control the transmittance or the reflectance of each of the plurality of pixels 51 so that the light intensity pattern in the plane direction of the control light CLM becomes close to the target pattern. The optical element 5 may include the liquid crystal spatial phase modulator. For example, by controlling the modulated light LM from the imaging system 3 by the above optical element 5, the light intensity of the control light CLM at a position other than the focusing position of the imaging system 6 on the photocurable material M can be suppressed.

As described with reference to FIGS. 7 to 13, the optical element 5A may control the modulated light LM from the imaging system 3 such that adjacent light beams of the light beams from portions in the plane direction (XY plane direction) of the control light CLM reach the focusing position of the imaging system 6 at different timings. For example, the optical element 5 may include a plurality of pixels 51A to which light beams from respective portions in the plane direction of the modulated light LM in the imaging system 3 enter, and adjacent pixels 51A of the plurality of pixels 51A may apply different optical path lengths to entering light beams. In that case, the optical element 5 may be a plate-like element configured such that adjacent pixels 51A of the plurality of pixels 51A have different thicknesses. The plate-like element may contain at least one of glass and resin. The optical element 5 may be the liquid crystal spatial phase modulator or the digital mirror device. For example, by controlling the modulated light LM from the imaging system 3 by the above optical element 5A, the light intensity of the control light CLM at a position other than the focusing position of the imaging system 6 on the photocurable material M can be suppressed.

As described with reference to FIGS. 11 to 16, the optical element 5B may control the modulated light LM from the imaging system 3 such that the pulse width of the control light CLM at a position other than the focusing position of the imaging system 6 on the photocurable material M is longer than the pulse width of the control light CLM at the focusing position. The optical element 5 may include the diffractive optical element. For example, also by controlling the modulated light LM from the imaging system 3 by the above optical element 5B, the light intensity of the control light CLM at a position other than the focusing position of the imaging system 6 on the photocurable material M can be suppressed.

The optical modeling method using the optical modeling apparatus 1 is also one of the disclosed technologies. As described with reference to FIGS. 1 to 11 and FIGS. 13 to 18, the optical modeling method includes modulating the laser beam L by the spatial light modulator 4 so as to have the light intensity pattern in the plane direction (XY plane direction) intersecting the traveling direction of the laser beam L and outputting the laser beam L as the modulated light LM, forming an image of the modulated light LM from the spatial light modulator 4 by the imaging system 3 (first imaging system), controlling the modulated light LM from the imaging system 3 and outputting the modulated light LM as the control light CLM by the optical element 5, and imaging the control light CLm from the optical element 5 and focusing and applying the control light CLM onto the photocurable material M by the imaging system 6 (second imaging system). The optical element 5 is disposed between the imaging system 3 and the imaging system 6 so as to suppress the light intensity of the control light CLM at a position other than the focusing position of the imaging system 6 on the photocurable material M. The above optical modeling method also achieves both high speed and precision modeling as described above.

Note that the effects described in the present disclosure are merely examples and are not limited to the subject matter disclosed. There may be other effects.

The technical scope of the present disclosure is not limited to the above-described embodiments, and various modifications can be made without departing from the gist of the present disclosure. In addition, the components of different embodiments and modifications may be appropriately combined.

The present technology may also have the following configurations.
(1) An optical modeling apparatus comprising:
   a spatial light modulator that modulates a laser beam so that the laser beam has a light intensity pattern in a plane direction intersecting a traveling direction of the laser beam, the spatial light modulator outputting the laser beam modulated as modulated light;
   a first imaging system that images the modulated light from the spatial light modulator;
   an optical element that controls the modulated light from the first imaging system, the optical element outputting the modulated light controlled as control light; and
   a second imaging system that images the control light from the optical element, the second imaging system focusing and applying the control light onto a photocurable material, wherein
   the optical element is disposed between the first imaging system and the second imaging system in order to suppress a light intensity of the control light at a position other than a focusing position of the second imaging system on the photocurable material.
(2) The optical modeling apparatus according to (1), wherein
   the optical element is disposed at a position of an image obtained by imaging the modulated light by the first imaging system or at a position closer to the position of the image than the first imaging system and the second imaging system.
(3) The optical modeling apparatus according to (1) or (2), wherein
   the optical element controls a light intensity of light beams of portions in the plane direction of the modulated light from the first imaging system.
(4) The optical modeling apparatus according to (3), wherein
   the optical element includes a plurality of pixels to which the light beams of the portions in the plane direction of the modulated light enter from the first imaging system, and controls transmittance or reflectance of each of the plurality of pixels.
(5) The optical modeling apparatus according to (4), wherein
   the optical element controls the transmittance or the reflectance of the each of the plurality of pixels such that a light intensity pattern in the plane direction of the control light becomes close to a target pattern.
(6) The optical modeling apparatus according to any one of (1) to (5), wherein
   the optical element includes a liquid crystal spatial phase modulator.
(7) The optical modeling apparatus according to any one of (1) to (6), wherein
   the optical element controls the modulated light from the first imaging system such that adjacent light beams among light beams of portions in the plane direction of the control light reach the focusing position of the second imaging system at different timings.
(8) The optical modeling apparatus according to (7), wherein
   the optical element includes a plurality of pixels to which light beams of portions in the plane direction of the modulated light enter from the first imaging system, and
   adjacent pixels among the plurality of pixels apply optical path lengths different from each other to the light beams entered.
(9) The optical modeling apparatus according to (8), wherein
   the optical element is a plate-like element configured such that the adjacent pixels among the plurality of pixels have different thicknesses.
(10) The optical modeling apparatus according to (9), wherein
   the plate-like element includes at least one of glass and resin.
(11) The optical modeling apparatus according to any one of (7) to (9), wherein
   the optical element is a liquid crystal spatial phase modulator or a digital mirror device.
(12) The optical modeling apparatus according to any one of (1) to (11), wherein
   the optical element controls the modulated light from the first imaging system such that a pulse width of the control light at the position other than the focusing position of the second imaging system on the photocurable material is longer than a pulse width of the control light at the focusing position.
(13) The optical modeling apparatus according to (12), wherein
   the optical element includes a diffractive optical element.
(14) An optical modeling method comprising:
   by a spatial light modulator, modulating a laser beam so that the laser beam has a light intensity pattern in a plane direction intersecting a traveling direction of the laser beam, and outputting the laser beam modulated as modulated light;
   imaging, by a first imaging system, the modulated light from the spatial light modulator;
   by an optical element, controlling the modulated light from the first imaging system, and outputting the modulated light controlled as control light; and
   by a second imaging system, imaging the control light from the optical element, and focusing and applying the control light onto a photocurable material, wherein
   the optical element is disposed between the first imaging system and the second imaging system so as to suppress a light intensity of the control light at a position other than a focusing position of the second imaging system on the photocurable material.

### REFERENCE SIGNS LIST

1 OPTICAL MODELING APPARATUS
2 LASER SOURCE
3 IMAGING SYSTEM
31 HALF MIRROR
4 SPATIAL LIGHT MODULATOR
41 PIXEL
5 OPTICAL ELEMENT
51 PIXEL
6 IMAGING SYSTEM
61 LENS
62 MIRROR
63 LENS
7 STAGE
C CONTAINER
CL1 COLLECTED LIGHT BEAM
CL2 COLLECTED LIGHT BEAM
CL3 COLLECTED LIGHT BEAM
CL4 COLLECTED LIGHT BEAM
FIM REDUCED IMAGE
IMM INTERMEDIATE IMAGE
L LASER BEAM
LM MODULATED LIGHT
CLM CONTROL LIGHT
M PHOTOCURABLE MATERIAL
ML LIGHT COLLECTING LAYER

1. An optical modeling apparatus comprising:
a spatial light modulator that modulates a laser beam so that the laser beam has a light intensity pattern in a plane direction intersecting a traveling direction of the laser beam, the spatial light modulator outputting the laser beam modulated as modulated light;
a first imaging system that images the modulated light from the spatial light modulator;
an optical element that controls the modulated light from the first imaging system, the optical element outputting the modulated light controlled as control light; and
a second imaging system that images the control light from the optical element, the second imaging system focusing and applying the control light onto a photocurable material, wherein
the optical element is disposed between the first imaging system and the second imaging system in order to suppress a light intensity of the control light at a position other than a focusing position of the second imaging system on the photocurable material.

2. The optical modeling apparatus according to claim 1, wherein
the optical element is disposed at a position of an image obtained by imaging the modulated light by the first imaging system or at a position closer to the position of the image than the first imaging system and the second imaging system.

3. The optical modeling apparatus according to claim 1, wherein
the optical element controls a light intensity of light beams of portions in the plane direction of the modulated light from the first imaging system.

4. The optical modeling apparatus according to claim 3, wherein
the optical element includes a plurality of pixels to which the light beams of the portions in the plane direction of the modulated light enter from the first imaging system, and controls transmittance or reflectance of each of the plurality of pixels.

5. The optical modeling apparatus according to claim 4, wherein
the optical element controls the transmittance or the reflectance of the each of the plurality of pixels such that a light intensity pattern in the plane direction of the control light becomes close to a target pattern.

6. The optical modeling apparatus according to claim 1, wherein
the optical element includes a liquid crystal spatial phase modulator.

7. The optical modeling apparatus according to claim 1, wherein
the optical element controls the modulated light from the first imaging system such that adjacent light beams among light beams of portions in the plane direction of the control light reach the focusing position of the second imaging system at different timings.

8. The optical modeling apparatus according to claim 7, wherein
the optical element includes a plurality of pixels to which light beams of portions in the plane direction of the modulated light enter from the first imaging system, and
adjacent pixels among the plurality of pixels apply optical path lengths different from each other to the light beams entered.

9. The optical modeling apparatus according to claim 8, wherein
the optical element is a plate-like element configured such that the adjacent pixels among the plurality of pixels have different thicknesses.

10. The optical modeling apparatus according to claim 9, wherein
the plate-like element includes at least one of glass and resin.

11. The optical modeling apparatus according to claim 7, wherein
the optical element is a liquid crystal spatial phase modulator or a digital mirror device.

12. The optical modeling apparatus according to claim 1, wherein
the optical element controls the modulated light from the first imaging system such that a pulse width of the control light at the position other than the focusing position of the second imaging system on the photocurable material is longer than a pulse width of the control light at the focusing position.

13. The optical modeling apparatus according to claim 12, wherein
the optical element includes a diffractive optical element.

14. An optical modeling method comprising:
by a spatial light modulator, modulating a laser beam so that the laser beam has a light intensity pattern in a plane direction intersecting a traveling direction of the laser beam, and outputting the laser beam modulated as modulated light;
imaging, by a first imaging system, the modulated light from the spatial light modulator;
by an optical element, controlling the modulated light from the first imaging system, and outputting the modulated light controlled as control light; and
by a second imaging system, imaging the control light from the optical element, and focusing and applying the control light onto a photocurable material, wherein
the optical element is disposed between the first imaging system and the second imaging system so as to suppress a light intensity of the control light at a position other than a focusing position of the second imaging system on the photocurable material.
